(19) United States
(12) Patent Application Publication
(10) Pub. No.: US 2026/0221884 A1
(43) Pub. Date: Jul. 30, 2026

(54) DC-DC CONVERTER USING PARALLEL POINT-OF-LOAD INTEGRATED CIRCUITS

(71) Applicant: Murata Manufacturing Co., Ltd., Nagaokakyo-shi (JP)

(72) Inventor: Takayuki TANGE, Milton Keynes (GB)

(21) Appl. No.: 19/456,094

(22) Filed: Jan. 22, 2026

Related U.S. Application Data
(60) Provisional application No. 63/749,082, filed on Jan. 24, 2025.

(51) Int. Cl. H02M 3/335

(52) U.S. Cl. CPC H02M 3/33571

(57) ABSTRACT

A converter includes a first stage that is connected to first and second input terminals and that includes a first-stage IC with a feedback terminal; parallel first and second half-bridge circuits, each of the first and second half-bridge circuits includes a half-bridge IC that receives a clock signal from the first stage; a transformer that includes a single magnetic core, a first primary winding that extends around the single magnetic core and that is connected to the first half-bridge circuit, a second primary winding that extends around the single magnetic core and that is connected to the second half-bridge circuit, and a secondary winding that extends around the single magnetic core; a rectifier connected to the secondary winding; first and second output terminals connected to the rectifier; and a feedback circuit connected between the first output terminal and the feedback terminal of the first-stage IC.

### CROSS REFERENCE TO RELATED APPLICATIONS

This application claims the benefit of U.S. Patent Application No. 63/749,082 filed on Jan. 24, 2025. The entire contents of this application are hereby incorporated by reference.

### BACKGROUND OF THE INVENTION

### 1. Field of the Invention

The present invention relates to converters. More specifically, the present invention relates to DC-DC converters that use point-of-load (POL) integrated circuits (ICs) connected in parallel to achieve resonant operation.

### 2. Description of the Related Art

When higher current is needed, it is known to scale up the IC, the transformer, and the electronic components in a DC-DC converter. Problems with scaling-up the DC-DC converter include that the transformer's height is increased to accommodate larger current and that larger ICs can have reliability issues.

### SUMMARY OF THE INVENTION

To overcome the problems described above, example embodiments of the present invention provide converters that includes a first stage and a second stage including half-bridge circuits, where each half-bridge circuit receives a clock signal from the first stage and where the first stage received a feedback signal of the second stage. Using multiple half-bridge circuits allows for more reliable ICs to be used and allows for the primary windings to be wound around the same magnetic core, which allows for the use of a smaller transformer.

According to an example embodiment of the present invention, a converter includes first and second input terminals; a first stage that is connected to the first and the second input terminals and that includes a first-stage integrated circuit (IC), the first-stage IC includes a feedback terminal; first and second half-bridge circuits that are connected in parallel and that receive an input voltage from the first stage, each of the first and second half-bridge circuits includes a half-bridge IC that receive a clock signal from the first stage; a transformer that includes a single magnetic core, a first primary winding that extends around the single magnetic core and that is connected to the first half-bridge circuit, a second primary winding that extends around the single magnetic core and that is connected to the second half-bridge circuit, and a secondary winding that extends around the single magnetic core; a rectifier connected to the secondary winding; first and second output terminals connected to the rectifier; and a feedback circuit connected between the first output terminal and the feedback terminal of the first-stage IC.

The half-bridge IC can be a non-resonant, step-down, and point-of-load IC, can receive the input voltage from the first stage, and can include a feedback terminal and a switch-output terminal; and a voltage-sense circuit can be connected to the feedback terminal of the half-bridge IC and the switch-output terminal of the half-bridge IC. The voltage-sense circuit cam includes a voltage divider defined by first and second resistors connected in series with each other; the first resistor can be directly connected to the switch-output terminal of the half-bridge IC; and a node between the first and the second resistors can be connected to the feedback terminal of the half-bridge IC. A signal received by the feedback terminal of the half-bridge IC from the voltage-sense circuit can causes the half-bridge IC to provide a 50% duty cycle or an approximately 50% duty cycle.

The first stage can be a buck converter. The first-stage IC can include a switch-output terminal that provides the input voltage. The feedback circuit can include an isolator, an optocoupler, or a signal isolator. The rectifier can include a full-bridge rectifier, a voltage-doubler circuit, or a voltage-quadrupler circuit. The magnetic core can have a ring-, rectangular-, oval-, or EI-shape.

The above and other features, elements, characteristics, steps, and advantages of the present invention will become more apparent from the following detailed description of example embodiments of the present invention with reference to the attached drawings.

### BRIEF DESCRIPTION OF THE DRAWINGS

FIG. 1 shows a first stage of a converter that can be used with the second stage shown in FIG. 2.

FIG. 2 shows a second stage of a converter that can be used with the first stage shown in FIG. 1.

FIG. 3 shows a converter that includes a first stage that includes a buck converter and a second stage that includes parallel POL ICs that receive a clock signal from the first stage.

FIG. 4 shows a secondary circuit with a full-bridge rectifier.

FIG. 5 shows a secondary circuit with a full-bridge rectifier and an inductor.

FIG. 6 shows a secondary circuit with a voltage quadrupler circuit.

FIG. 7 shows a secondary circuit with a voltage doubler circuit.

FIG. 8 shows a secondary circuit with another voltage doubler circuit.

FIG. 9 shows a primary circuit of a second stage of a converter with a capacitive divider.

FIG. 10 shows a primary circuit of a second stage of a converter with a capacitive divider and a resonant capacitor.

FIG. 11 shows an example of an isolator that can be used with the converter shown in FIGS. 1 and 2.

### DETAILED DESCRIPTION OF EXAMPLE EMBODIMENTS

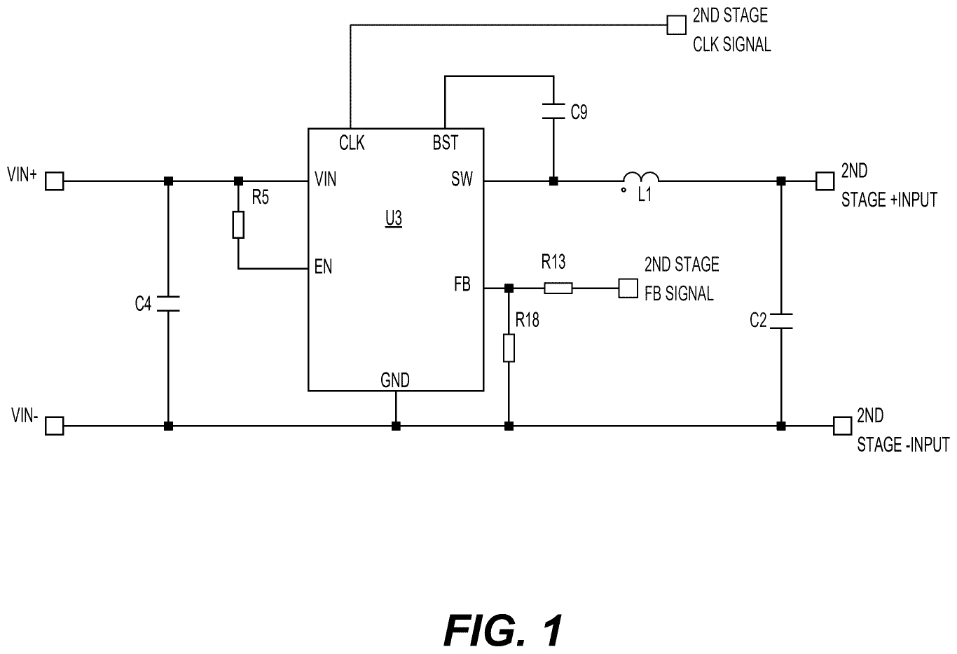

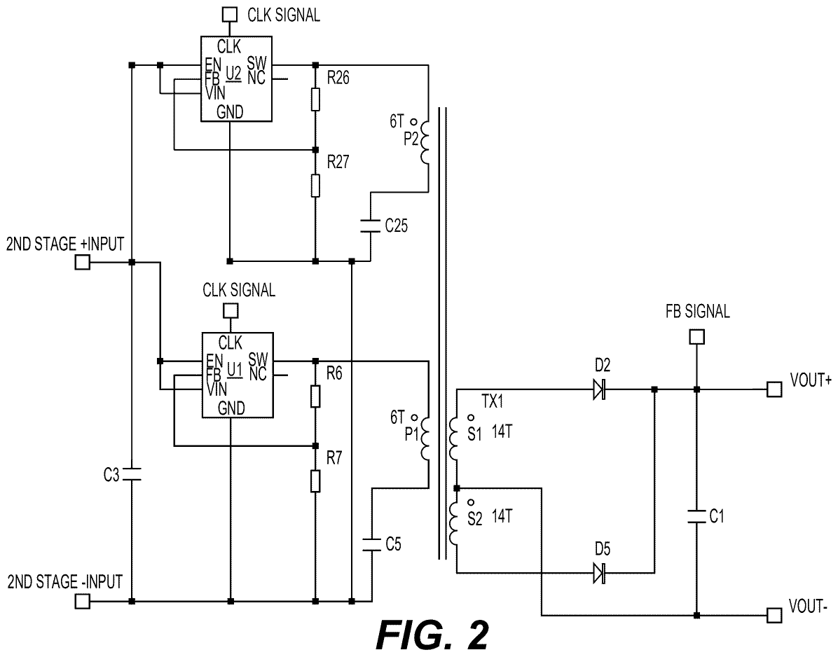

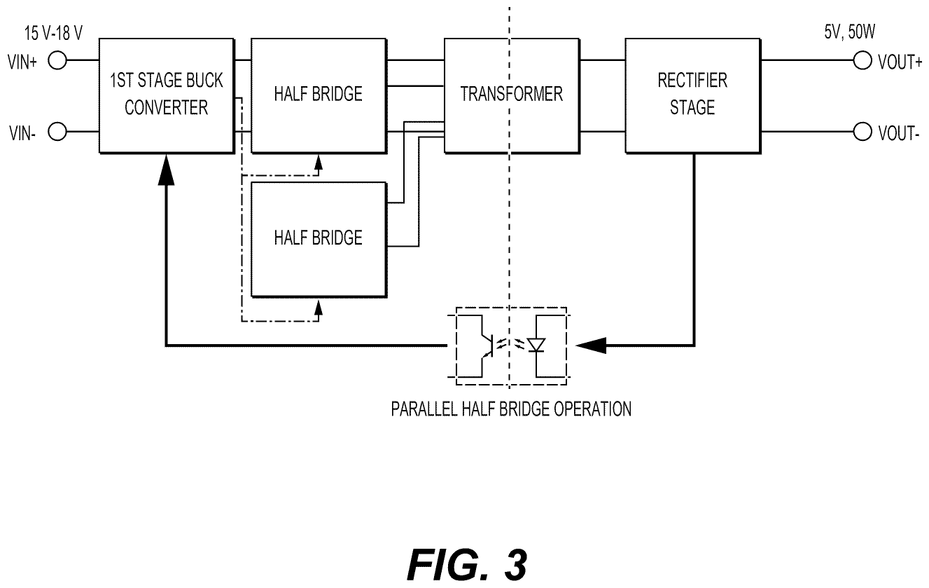

FIGS. 1 and 2 show a first stage and a second stage of a converter. FIG. 1 shows the first stage that provides an input for the second stage of FIG. 2. FIG. 3 shows a converter that includes a first stage connected to a second stage. The second stage includes two half-bridge circuits connected in parallel and includes a transformer that is connected between the two parallel half-bridge circuits and a rectification stage or rectifier. Although FIG. 3 shows two half-bridge circuits in the second stage, any number of half-bridge circuits can be used. The first stage includes input voltage terminals Vin+, Vin− that receive an input voltage, and the rectification stage or rectifier includes output voltage terminals Vout+, Vout− that provide an output voltage. FIG. 3 shows that the input voltage can be about 15 V-about 18 V, and the output voltage can be about 5 V at a power of about 50 W, but any other values can also be used. The first stage in FIG. 3 can include the first stage of FIG. 1, and the second stage in FIG. 3 can include the second stage of FIG. 2. Alternatively, in FIG. 3, it is possible to use a different first stage and/or to use a different second stage.

In FIG. 3, the first-stage output voltage, which is the second-stage input voltage, can be adjusted using a feedback signal of a feedback circuit based on the second-stage output voltage. The feedback signal of the feedback circuit can be transmitted across the isolation boundary (shown by the dashed line in FIG. 3) provided by the transformer by using an isolator, which can be, for example, an optocoupler, an insulating signal isolator, etc. FIGS. 1 and 2 show that the feedback terminal FB of IC U3 of FIG. 1 is connected to the terminal FB SIGNAL of FIG. 2, which is connected to the output voltage VOUT+. Neither FIG. 1 nor FIG. 2 shows an isolator, but it should be understood that an isolator can be connected between the feedback terminal FB of IC U3 of FIG. 1 and the terminal FB SIGNAL to transmit the feedback signal across the isolation boundary provided by the transformer TX1 of FIG. 2.

In FIG. 3, the clock signal of the ICs of the half-bridge circuits can be connected to the first stage to synchronize the frequency and the phase of the half-bridge circuits. For example, the first stage can include an IC that can provide a clock signal or a synchronization signal (shown by the dash-dot line in FIG. 3), and the second stage can includes an IC that receives the clock signal or a synchronization signal, which can be used to synchronize the frequency and the phase of the half-bridge circuits. Alternatively, the ICs of the half-bridge circuits can be connected to output terminal of the IC in the first stage.

In FIG. 3, the core of the transformer can have a ring-, rectangular-, oval-, or EI-shape, and the primary windings of each half-bridge circuit can be wound around the same magnetic core, which allows for the use of a small transformer, even in high-power applications. The secondary windings can also be wound around the same magnetic core.

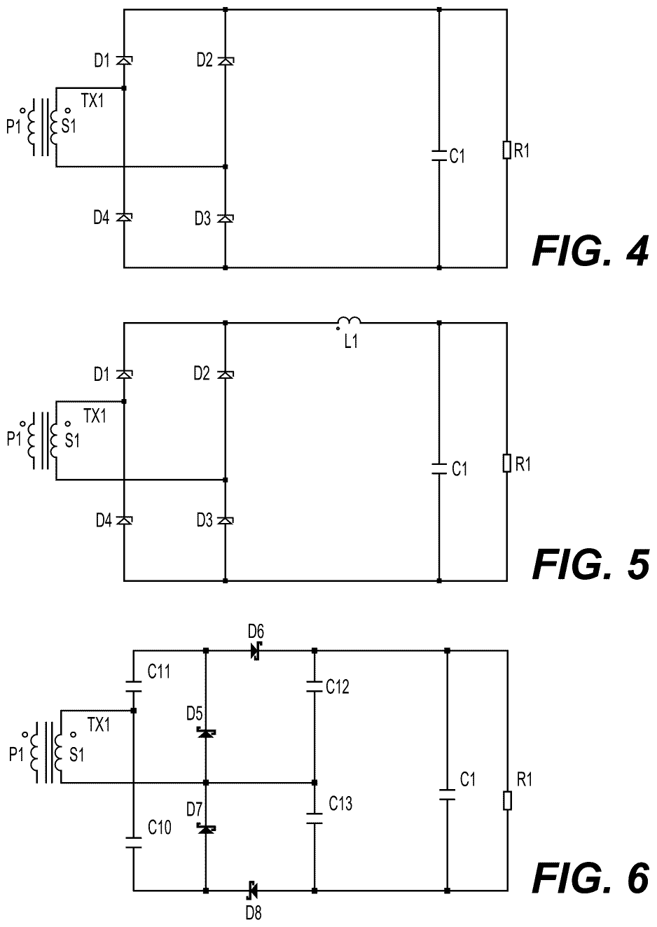

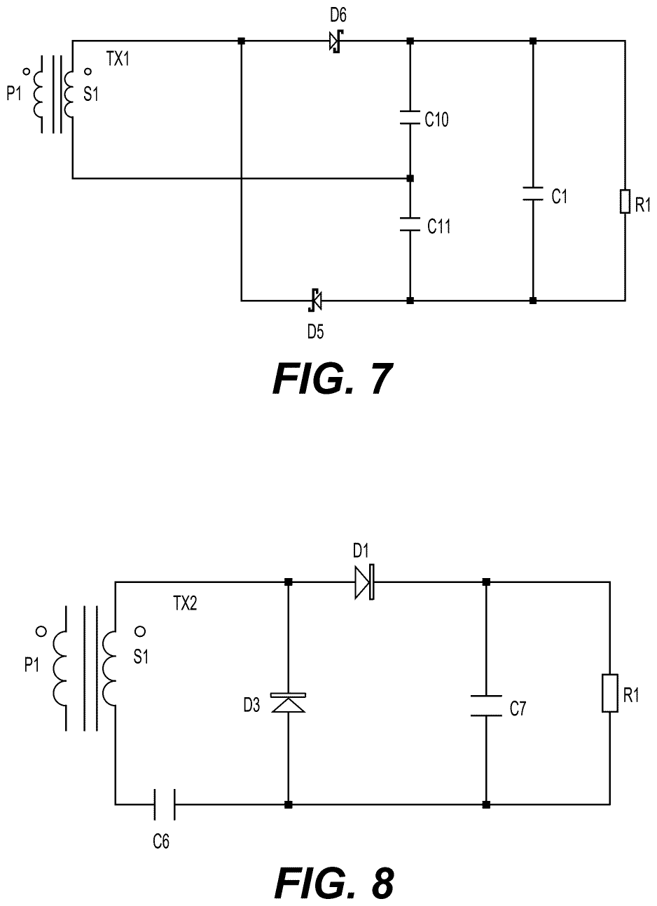

In FIG. 3, the rectification stage or rectifier can include diodes and possibly capacitors. For example, the rectification stage can include diodes D2, D5 as shown in FIG. 2. But other configurations are also possible, as shown in FIGS. 4-8. For example, the rectification stage can include four diodes D1, D2, D3, D4 arranged in a full-bridge arrangement as shown in FIGS. 4 and 5, can include four capacitors C10, C11, C12, C13 and three diodes D5, D6, D7 arranged as a voltage quadrupler as shown in FIG. 6, or can include two capacitors C10, C11 and two diodes D5, D6 arranged as a voltage doubler as shown in FIG. 7.

In FIG. 3, the first-stage output voltage, which is also the second-stage input voltage, can be adjusted by a feedback signal of a feedback circuit that is transmitted from the secondary side of the transformer by an isolator, which can include an optocoupler or any other signal isolator. The second stage can include two or more half-bridge circuits, which can include the POL IC U1 of FIG. 2. As shown in FIG. 3, the ICs of the half-bridge circuits can be connected to the clock signal of the first-stage to synchronize frequency and phase. The transformer can include one magnetic core, which can have any shape, including ring, rectangle, oval, and EI. The primary windings of each half-bridge circuit can be wound around the same magnetic core.

The first stage of FIG. 3 can be a buck converter. For example, the first stage of FIG. 3 can include the first stage of FIG. 1 as a pre-regulator stage, and the second stage of FIG. 3 can include the second stage of FIG. 2. FIG. 2 shows a first half bridge circuit that includes a first IC U1 connected in parallel with a second half bridge circuit that includes a second IC U2. As shown in FIG. 3, the parallel-connected half-bridge circuits can be connected between the first stage (pre-regulator stage) and the transformer, with a rectifier stage connected to the transformer.

Although larger ICs are capable of handling larger currents, the size of ICs is limited, which is currently about 5 mm×about 6 mm, because loss and heat negatively affect reliability of the ICs as ICs increase in size.

FIG. 2 shows a possible second stage of a converter. The second stage includes a transformer TX1 that divides the second stage into a primary side (on the left side of FIG. 2) and a secondary side (on the right side of FIG. 2). The transformer TX1 includes two primary windings P1, P2 and two secondary windings S1, S2. As shown in FIG. 2, the primary windings P1, P2 can include 6 turns, and the secondary windings S1, S2 can include 14 turns. The primary windings P1, P2 and the secondary windings S1, S2 can have any number of turns. The primary windings P1, P2 can be wound around the same magnetic core. The magnetic core can have any suitable shape, including, for example, ring-, rectangular-, oval-, or EI-shape. The secondary windings S1, S2 can also be would around the same magnetic core. The second stage can include two half-bridge circuits connected in parallel. Each half-bridge circuit can include an IC U1 or U2 connected to the primary winding P1 or P2.

The primary side of the second stage includes an IC U1 that includes a power switch or power switches and an IC U2 that includes a power switch or power switches. Both ICs U1, U2 can include an input voltage terminal VIN; an enable terminal EN that turns on the IC U1 when a voltage is applied and that turns off the IC U1 when no voltage is applied; a switch-output terminal SW connected to an output of the power switch or the power switches; a feedback terminal FB that monitors the output of the IC U1; a clock or synchronization terminal CLK; and a ground terminal GND. The ICs U1, U2 can include a not-connected terminal NC that is not connected to any other element of the converter. The not-connected terminal NC can be allowed to float.

The primary side of the second stage can include input terminals +input, −input that are connected to input capacitor C3. The input terminal +input and a first terminal of the input capacitor C3 can be connected to the input voltage terminals VIN and the enable terminals EN of t. The input terminal −input and a second terminal of the input capacitor C3 can be connected to the ground terminals GND of the ICs U1, U2. The switch-output terminal SW of IC U1 can be connected to the primary winding P1, and the switch-output terminal SW of IC U2 can be connected to the primary winding P2. The primary winding P1 can be connected in series with a capacitor C5, and the primary winding P2 can be connected in series with a capacitor C25.

The feedback terminal FB of IC1 can be connected to the switch-output terminal SW of IC1. The feedback terminal FB of IC1 can be connected to the switch-output terminal SW of IC1 before any inductor or LC filter connected to the switch-output terminal of IC1. As shown in FIG. 2, the feedback terminal FB of IC1 can be connected to the switch-output terminal SW of IC1 through a voltage divider defined by resistors R6, R7 that are connected in series across the switch-output terminal SW of IC1 and the input terminal −input. The feedback terminal FB of IC2 can be connected to the switch-output terminal SW of IC2. The feedback terminal FB of IC2 can be connected to the switch-output terminal SW of IC2 before any inductor or LC filter connected to the switch-output terminal of IC2. As shown in FIG. 2, the feedback terminal FB of IC2 can be connected to the switch-output terminal SW of IC2 through a voltage divider defined by resistors R26, R27 that are connected in series across the switch-output terminal SW of IC2 and the input terminal −input.

The ICs U1, U2 can be a non-resonant, step-down POL IC, which can include an internal high-side power switch and an internal low-side power switch connected in series with each other and connected to the input voltage and which can include a forced continuous-conduction mode (CCM) function that allows negative current to flow into the internal low-side switch. Some POL ICs include discontinuous mode (DCM) at light-load conditions to improve efficiency by preventing negative current. Usually, the POL IC detects negative current in the inductor by detecting a voltage drop in the low-side switch. Once the POL IC detects the negative voltage drop, the switch is turned off to prevent negative current into the switch. On the other hand, if a POL IC is used in an isolated half-bridge converter, the flow of the inductor current is negative in each cycle. If the POL IC includes DCM function, the negative current is prevented by DCM control, preventing the converter from working properly. Based on a feedback signal of the output voltage, the non-resonant, step-down POL IC can regulate the output voltage by changing the duty cycle of the internal high-side and low-side power switches. An example of a non-resonant, step-down POL IC that can be used is Texas Instruments'TLV62568A as described in the datasheet: Texas Instruments, “TLV6256xA 1-A, 2-A Step Down Converter with Forced PWM in SOT 563 Package,” revised March 2020, 23 pages, which is incorporated herein by reference in its entirety. The ICs U1, U2 do not have to include pulse frequency modulation (PFM) control at light loads (or the ability to disable PFM control), a pulse-skipping mode, or any light-load efficiency-improvement feature.

In each of the half-bridge circuits in FIG. 2, the feedback terminal FB is connected to the switch-output terminal SW through a voltage-sense circuit that can include a voltage divider defined by the resistors R6, R7 or the resistors R26, R27, where the resistor R6, R26 can be directly connected to the switch-output terminal SW and before any inductor or transformer winding that receives the output of the switch-output terminal SW. An average of the voltage at the switch-output terminal SW voltage is maintained by the voltage divider defined by resistors R6, R7 or R26, R27, keeping constant the voltage on the feedback terminal FB. The ICs U1, U2 can include an internal operational amplifier (OP amp) (not shown) that includes a plus terminal connected to a reference voltage and a negative terminal connected to the node between the resistors R6, R7 or R26, R27 through the feedback terminal FB. When the reference voltage applied to the plus terminal and the voltage on the feedback terminal applied to the negative terminal are the same, the plus and negative terminals of the internal OP amp can be considered to be imaginarily shorted. Connecting the feedback terminal FB to the switch-output terminal SW can achieve 50% duty cycle operation which is required in resonance operation. Exact 50% duty cycle is not required. Approximately 50% duty cycle, e.g., 47.5%-52.5% duty cycle, can still be used to achieve resonance operation. Resonance operation avoids instability issues that are normally caused by the LC filter defined by the primary winding P1 and the capacitor C5 or defined by the primary winding P2 and the capacitor C25 because of less gain and phase margin in the control loop. The LC filter defined by the primary winding P1 and the capacitor C5 or defined by the primary winding P2 and the capacitor C25 includes an 180°-phase shift and an increased gain at the resonant frequency. If the gain with a 180°-phase shift of the LC filter defined by the primary winding P1 and the capacitor C5 or defined by the primary winding P2 and the capacitor C25 is too large, then the convertor can oscillate. Using a non-resonant step-down POL IC as shown in FIG. 2 can eliminate or significantly reduce the effect that the LC filter defined by the primary winding P1 and the capacitor C5 or defined by the primary winding P2 and the capacitor C25 on the control of the converter. The switching frequency of the IC U1 can be matched to the resonance frequency of a resonant circuit defined by the leakage inductance of the primary winding P1 and the capacitance of the capacitor C5 by adjusting the values of the leakage inductance of the primary winding P1 and the capacitance of the capacitor C5, and the switching frequency of the IC U2 can be matched to the resonance frequency of a resonant circuit defined by the leakage inductance of the primary winding P2 and the capacitance of the capacitor C25 by adjusting the values of the leakage inductance of the primary winding P2 and the capacitance of the capacitor C25. The feedback terminal FB of IC U1 can be connected to the switch-output terminal SW, with the voltage across the capacitor C5 being about 5 V, within manufacturing and/or measurement tolerances, and with the output current Iout being about 0.2 A, within manufacturing and/or measurement tolerances, and the feedback terminal FB of IC U2 can be connected to the switch-output terminal SW, with the voltage across the capacitor C25 being about 5 V, within manufacturing and/or measurement tolerances, and with the output current Iout being about 0.2 A, within manufacturing and/or measurement tolerances. Load regulation of the second stage can be improved, by about 12%, within manufacturing and/or measurement tolerances.

The clock or synchronization terminal CLK of ICs U1, U2 of the second stage can be connected to the clock or synchronization terminal CLK of IC U3 of the first stage to synchronize the frequency and phase of the half-bridge circuits.

It is possible to use the signal from the switch-output terminal SW instead of the clock or synchronization terminal CLK of IC U3. The signal provided by the switch-output terminal SW is turned on and off at certain frequency, which can provide the same or similar information as the signal from the clock or synchronization terminal CLK. The logic circuits connected to the clock or synchronization terminals CLK of ICs U1, U2 can withstand up to about 5 V, for example. If the voltage of the signal provided by the switch-output terminal SW does not exceed 5V, then it is possible for the switch-output terminal SW of U3 to be directly connected to the clock or synchronization terminals CLK of ICs U1, U2. If the voltage of the signal provided by the switch-output terminal SW sometimes exceed 5 V, then a voltage divider can be used to lower voltage of the switch-output terminal SW of U3 so that the lowered voltage can be connected to the clock or synchronization terminals CLK of ICs U1, U2.

The secondary side of the second stage can include rectifying diodes D2, D5 and output capacitor C1. The anode of the diode D2 can be connected to one end of the secondary winding S1. The other end of the secondary winding S1 can be connected to the one end of the secondary winding S2 to define a tap. The anode of the diode D5 can be connected to the other end of the secondary winding S2. One end of the output capacitor C1 can be connected to cathodes of the diodes D2, D5 and to the output terminal Vout+, and the other end of the output capacitor C1 can be connected to the tap between the secondary windings S1, S2 and to the output terminal Vout−.

The output voltage VOUT+ of the second stage of FIG. 2 can be supplied to the first stage of FIG. 1 as a feedback signal FB SIGNAL. The feedback signal FB SIGNAL can be supplied to the feedback terminal FB of the IC U3 to control the voltage supplied by the switch-output terminal SW.

FIG. 1 is a possible first stage of a converter that can be used with the second stage of FIG. 2 as a pre-regulator. The first stage can be used to reduce fluctuations in the input voltage provided to the second stage. The first stage includes an IC U3 that includes a power switch or power switches. The IC U3 includes an input voltage terminal VIN; an enable terminal EN that turns on the IC U3 when a voltage is applied and that turns off the IC U3 when no voltage is applied; a switch-output terminal SW connected to an output of the power switch or the power switches; a feedback terminal FB; a bootstrap terminal BST that can be connected to the switch-output terminal SW through capacitor C9; a clock or synchronization terminal CLK; and a ground terminal GND.

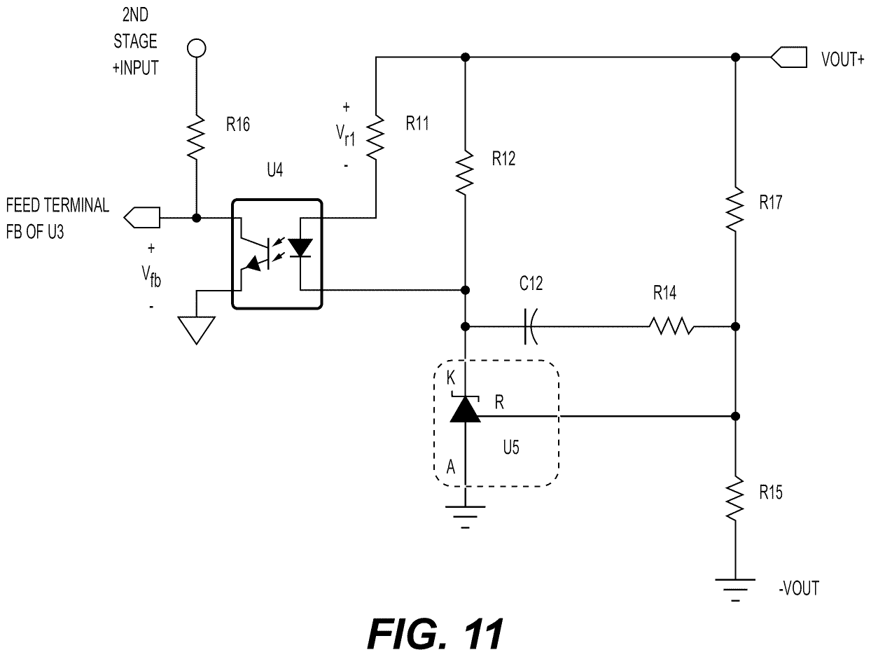

The first stage can include input terminals Vin+, Vin− that receive an input voltage and can include output terminals +input and −input that are connected to the second stage. The input terminals Vin+, Vin− are connected to an input capacitor C4. The input terminal Vin+ and a first terminal of the input capacitor C4 can be connected to the input voltage terminal VIN and can be connected to the enable terminal EN through resistor R5. The input terminal Vin+ and a second terminal of the input capacitor C4 can be connected to the ground terminal GND and to the output terminal −input. The switch-output terminal SW can be connected to an output capacitor C2 and the output terminal +input through inductor L1. The feedback terminal FB can be connected to the output voltage terminal VOUT+ of the second stage by a voltage divider defined by resistors R13, R18 that are connected in series between the output voltage terminal VOUT+ of the second stage and the input terminal VIN− of the first stage. Although not shown in FIGS. 1 and 2, the connection between the feedback terminal FB of U3 and the output voltage terminal VOUT+ of the second stage can include an isolator. Any suitable isolator can be used. An example of an isolator is shown in FIG. 11.

The isolator in FIG. 11 includes an optocoupler U4 connected between the feedback terminal FB of U3 and the output voltage terminal VOUT+ of the second stage to provide isolation. A voltage divider defined by resistors R14, R17 connected in series across the output voltage Vout+ and ground determines the output voltage Vout+ on the reference terminal R of the shunt voltage regulator U5. A compensation circuit including capacitor C1 and resistor R14 connected in series between the cathode terminal K of the shunt voltage regulator U5 and a node between the resistors R14, R17 can be used to stabilize circuit operation. An adjuster circuit including resistors R11, R12 can be used to adjust the current through resistor R16. The current through resistor R16 is defined by the gain of the optocoupler U4, and the LED current of the optocoupler U4 is determined by resistors R11, R12 in the adjuster circuit. The resistor R16 is connected to the second stage +input (i.e., the first stage +output), which is controlled by the feedback terminal FB of IC U3.

As explained above, the clock or synchronization terminal CLK of the IC U3 can be connected to the clock or synchronization terminal CLK of the ICs U1, U2.

The IC U3 can be a step-down IC. The IC U3 can accept a wide input voltage, e.g. about 4.5 V to about 24 V, within manufacturing and/or measurement tolerances, and can provide a fixed output voltage of the first stage that is provided to the second stage (i.e., the fixed input voltage received by the second stage) so that the second stage maintains a 50% duty cycle, which allows resonance operation in the second stage. Allowing the second stage to maintain a 50% duty cycle can eliminate the need for line regulation in the second stage and can achieve constant output voltage with wide input voltage. In addition, the output voltage accuracy can be set both by adjusting the transformer ratio and by adjusting the output voltage of the second stage. The output voltage of the first stage (i.e., the input voltage of the second stage) can be set accurately by the voltage divider defined by resistors R13, R18. The resistors R6, R7 in the second stage can be adjusted in accordance the input voltage of the second stage to keep 50% duty cycle and thus resonance operation.

The converters discussed above can use different primary and secondary circuits. FIGS. 4-10 show different examples of secondary and primary circuits that can be used. Any combination of these primary and secondary circuits can be used in the converters discussed above. In addition, the diodes in FIGS. 4-8 can be replaced with field-effect transistors (FETs) to increase efficiency.

FIG. 4 shows a secondary circuit with a full-bridge rectifier connected to the secondary winding S1 and the output capacitor C1. The full-bridge rectifier is defined by diodes D1, D2, D3, and D4. The resistor R1 represents the load. FIG. 5 shows a secondary circuit similar to the secondary circuit of FIG. 4, but the full-bridge rectifier is connected to the inductor L1. The cathodes of diodes D1 and D2 are connected to the inductor L1.

FIG. 6 shows a secondary circuit including capacitors C10-C13 and diodes D5-D8 arranged as a voltage quadrupler circuit. The voltage quadrupler circuit is connected to the output capacitor C1. The resistor R1 represents the load. FIG. 7 shows a secondary circuit including capacitors C10, C11 and diodes D5, D6 arranged as a voltage-doubler circuit. The voltage-doubler circuit is connected to output capacitor C1. FIG. 8 shows a secondary circuit including capacitors C6, C7 and diodes D1, D3 arranged in another voltage-doubler circuit. FIG. 8 includes one less component than FIG. 7 as only one capacitor is used, but when the diode D3 is conducting, current only flows into capacitor C6. In contrast, FIG. 7 includes an additional capacitor, but when the diode D5 is conducting, current flows not only into the capacitor C11 but also from capacitor C10. Thus, the voltage double of FIG. 7 is more expensive but more efficient than the voltage double of FIG. 8.

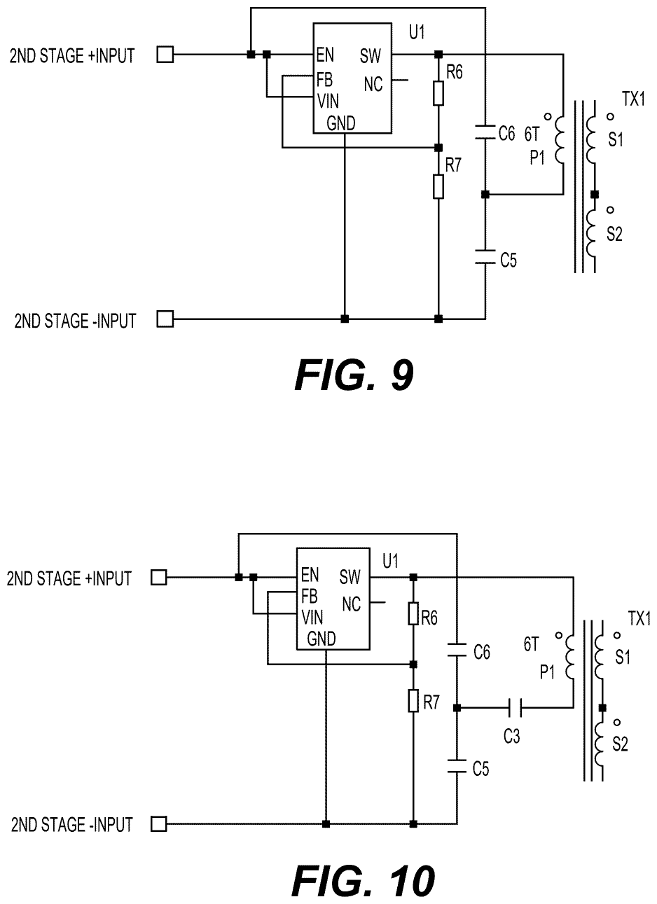

FIG. 9 shows a primary circuit of a second stage of a converter with a capacitive divider. The capacitor divider includes capacitors C5, C6 connected in series with each other and across the input terminals +input, −input. A node between the capacitors C5, C6 is connected to the primary winding P1. When the low-side switch in IC U1 is on, current is received from both capacitors C5, C6, instead of only capacitor C5. Sharing current between capacitors C5, C6 improves efficiency. FIG. 10 shows a primary circuit of a second stage of a converter similar to the primary circuit of FIG. 9. The primary circuit in FIG. 10 additionally includes a resonant capacitor C3 connected to the node between the capacitors C5, C6 and the primary winding P1.

The converter shown in FIG. 3 can be used by any boost converter technology, including, for example, LED boost converters and wireless charging technology.

It should be understood that the foregoing description is only illustrative of the present invention. Various alternatives and modifications can be devised by those skilled in the art without departing from the present invention. Accordingly, the present invention is intended to embrace all such alternatives, modifications, and variances that fall within the scope of the appended claims.

What is claimed is:

1. A converter comprising:
first and second input terminals;
a first stage that is connected to the first and the second input terminals and that includes a first-stage integrated circuit (IC), the first-stage IC includes a feedback terminal;
first and second half-bridge circuits that are connected in parallel and that receive an input voltage from the first stage, each of the first and the second half-bridge circuits includes a half-bridge IC that receives a clock signal from the first stage;
a transformer that includes:
a single magnetic core;
a first primary winding that extends around the single magnetic core and that is connected to the first half-bridge circuit;
a second primary winding that extends around the single magnetic core and that is connected to the second half-bridge circuit; and
a secondary winding that extends around the single magnetic core;
a rectifier connected to the secondary winding;
first and second output terminals connected to the rectifier; and
a feedback circuit connected between the first output terminal and the feedback terminal of the first-stage IC.

2. The converter of claim 1, wherein
the half-bridge IC is a non-resonant, step-down, and point-of-load IC, receives the input voltage from the first stage, and includes a feedback terminal and a switch-output terminal; and
a voltage-sense circuit is connected to the feedback terminal of the half-bridge IC and the switch-output terminal of the half-bridge IC.

3. The converter of claim 2, wherein
the voltage-sense circuit includes a voltage divider defined by first and second resistors connected in series with each other;
the first resistor is directly connected to the switch-output terminal of the half-bridge IC; and
a node between the first and the second resistors is connected to the feedback terminal of the half-bridge IC.

4. The converter of claim 2, wherein a signal received by the feedback terminal of the half-bridge IC from the voltage-sense circuit causes the half-bridge IC to provide a 50% duty cycle or an approximately 50% duty cycle.

5. The converter of claim 1, wherein the first stage is a buck converter.

6. The converter of claim 1, wherein the first-stage IC includes a switch-output terminal that provides the input voltage.

7. The converter of claim 1, wherein the feedback circuit includes an isolator, an optocoupler, or a signal isolator.

8. The converter of claim 1, wherein the rectifier includes a full-bridge rectifier, a voltage-doubler circuit, or a voltage-quadrupler circuit.

9. The converter of claim 1, wherein the magnetic core has a ring-, rectangular-, oval-, or EI-shape.
